(19) United States
(12) Patent Application Publication
(10) Pub. No.: US 2010/0131249 A1
(43) Pub. Date: May 27, 2010

(54) METHOD AND APPARATUS FOR SUPPORTING VERIFICATION OF LEAKAGE CURRENT DISTRIBUTION

(75) Inventor: Katsumi HOMMA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/561,490

(22) Filed: Sep. 17, 2009

(30) Foreign Application Priority Data
Nov. 25, 2008 (JP) 2008-299603

(51) Int. Cl. G06F 17/50; G06F 17/10

(52) U.S. Cl. 703/2; 703/14

(57) ABSTRACT

A leakage current distribution verification support method includes a process including obtaining the estimated number L of cells in the custom macro circuit and the first arithmetic expression including a polynomial with a term having a common parameter α representing variations arising from each cell in the custom macro circuit and with a term having a parameter β representing variations arising from the entirety of the custom macro circuit, generating a second arithmetic expression including a polynomial with a term having a parameter αₙ (n=1, 2, . . . , L) and a term having the parameter β, setting coefficients in the polynomial included in the second arithmetic expression in such a manner that a result of calculation of the second arithmetic expression becomes equal to a result of calculation of the first arithmetic expression, and outputting the second arithmetic expression in which the coefficients have been set.

### CROSS-REFERENCE TO RELATED APPLICATIONS

This application is based upon and claims the benefit of priority of the prior Japanese Patent Application No.2008-299603, filed on Nov. 25, 2008, the entire contents of which are incorporated herein by reference.

### FIELD

The embodiments discussed herein are related to method and apparatus for supporting verification of leakage current distribution which are intended for an electronic circuit including a custom macro circuit having an unknown internal configuration.

### BACKGROUND

Hitherto, analysis of leakage current distribution has been demanded for ensuring improved performance of an electronic circuit. The leakage current is a current which flows through a place on the electronic circuit other than a place such as wiring, elements, and other places originally designed to allow a current to flow therethrough. When such a leakage current flows, power consumption will increase and excessive heat will be generated in the electronic circuit, leading to degradation in circuit performance. Accordingly, to design a high-performance and malfunction-free electronic circuit, it is necessary to accurately estimate the leakage current distribution within the circuit in designing the circuit, to take an appropriate action against the leakage current.

Recently, as it has been required to further increase the packing density of electronic circuits, circuit design has correspondingly become increasingly finer. For example, an on-chip line width of 65 nm or 45 nm is adopted as a process rule (minimum processing dimension). With such miniaturization of electronic circuits, variations in the leakage current tend to increase due to finer process rule.

Therefore, there is a demand for statistical analysis which can estimate a leakage current in a circuit more accurately in consideration of variations therein.

FIG. 1 schematically illustrates statistical leakage analysis. To estimate a leakage current within a circuit in a target chip 1400 through statistical leakage analysis, a model representing variations in the leakage current in each cell (for example, an arithmetic expression such as the expression (1) described below) is first configured (S1000), as illustrated step 1400 in FIG. 14. After that, the models representing variations in the leakage current in the respective cells in entire circuit can be summed up (S1001) to determine the leakage distribution in the entire target chip 1400 by Monte Carlo simulation (S1002).

Leakage current I=exp (a+b*αₙ+c*β+p*αₙ²+q*αₙ*β+r*β²) (1)

α: a parameter representing variations arising from each cell

β: a parameter representing variations arising from an entire circuit

Recently, chips, however, include a circuit which has a large number of cells and an unknown internal configuration, the circuit being known as a custom macro circuit. FIG. 2 illustrates a procedure of analyzing leakage current distribution in the custom macro circuit. To analyze leakage current distribution in an electronic circuit including a custom macro circuit 1500, first of all, it is necessary to convert the custom macro circuit 1500 into an equivalent circuit 1520 using a custom macro analyzing tool 1510, as illustrated in FIG. 2. After that, the leakage current distribution in the equivalent circuit 1520 that has been converted is calculated by Monte Carlo simulation in which a simulation using a simulation program with integrated circuit emphasis (SPICE) is performed repeatedly.

However, the conversion process into the equivalent circuit performed by the custom macro analyzing tool 1510 as well as the Monte Carlo simulation performed by the equivalent circuit, as described above, take considerable processing time. It is thus difficult to use them as a tool for verification of the leakage current distribution when a circuit is actually designed. Japanese Laid-open Patent Publication No. 2005-71360 is a related-art example regarding leakage current.

### SUMMARY

According to an aspect of the invention, a computer readable storage medium stores a leakage current distribution verification program for causing a computer to execute obtaining a first arithmetic expression and an estimated number L of cells in a custom macro circuit, the first arithmetic expression being an arithmetic expression representing variations in a leakage current in the custom macro circuit having an unknown internal configuration, the first arithmetic expression including a polynomial with a term having a common parameter α representing variations arising from each cell in the custom macro circuit and with a term having a parameter β representing variations arising from the entirety of the custom macro circuit, generating a second arithmetic expression, as an arithmetic expression representing variations in the leakage current in consideration of an internal configuration of the custom macro circuit, the second arithmetic expression including a polynomial with a term having a parameter αₙ (n=1, 2, . . . , L) and a term having the parameter β, the parameter αₙ representing variations arising from each of the estimated number L of the cells, the estimated number L having been obtained by the obtaining procedure, setting coefficients in the polynomial included in the second arithmetic expression in such a manner that a result of calculation of the second arithmetic expression generated by the generating procedure becomes equal to a result of calculation of the first arithmetic expression obtained by the obtaining procedure, and outputting the second arithmetic expression in which the coefficients have been set by the setting procedure, as an arithmetic expression for use in verification of leakage current distribution in the custom macro circuit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 schematically illustrates statistical leakage analysis in the known art;

FIG. 2 illustrates a procedure of analyzing leakage current distribution in a custom macro circuit in the known art;

FIG. 3 schematically illustrates support for verification of leakage current distribution according to the present embodiment;

FIG. 4 is a block diagram illustrating a hardware configuration of a leakage current distribution verification supporting apparatus according to the present embodiment;

FIG. 5 is a block diagram illustrating a functional configuration of a leakage current distribution verification supporting apparatus according to the present embodiment;

FIG. 6 is a block diagram illustrating a configuration of a leakage current distribution verification supporting apparatus according to the first embodiment;

FIG. 7 is a table illustrating by way of example a format of data regarding a result of a macro leakage current corner simulation;

FIG. 8 is a table illustrating by way of example a format of data regarding a macro leakage current model;

FIG. 9 is a table illustrating by way of example a format of data regarding a cell leakage current model;

FIG. 10 is a table illustrating by way of example a format of data regarding circuit leakage current CDF;

FIG. 11 is a flowchart illustrating the procedure of processing for supporting verification of leakage current distribution according to the first embodiment;

FIG. 12 is a block diagram illustrating a configuration of a leakage current distribution verification supporting apparatus according to the second embodiment;

FIG. 13 is a table illustrating by way of example a format of data regarding a result of a partial circuit leakage current corner simulation;

FIG. 14 is a table illustrating by way of example a format of data regarding the number of cells in a partial circuit;

FIG. 15 is a table illustrating by way of example a format of data regarding a partial circuit leakage current model;

FIG. 16 is a table illustrating by way of example a format of data regarding a cell leakage current model;

FIG. 17 is a flowchart illustrating a procedure of processing for supporting verification of leakage current distribution according to the second embodiment;

FIG. 18 illustrates a process of model formula fitting;

FIG. 19 illustrates by way of example a model of leakage current distribution in a partial circuit;

FIG. 20 illustrates processing of configuring leakage current model for each cell; and

FIG. 21 illustrates processing of calculating macro leakage current distribution using the Monte Carlo simulation.

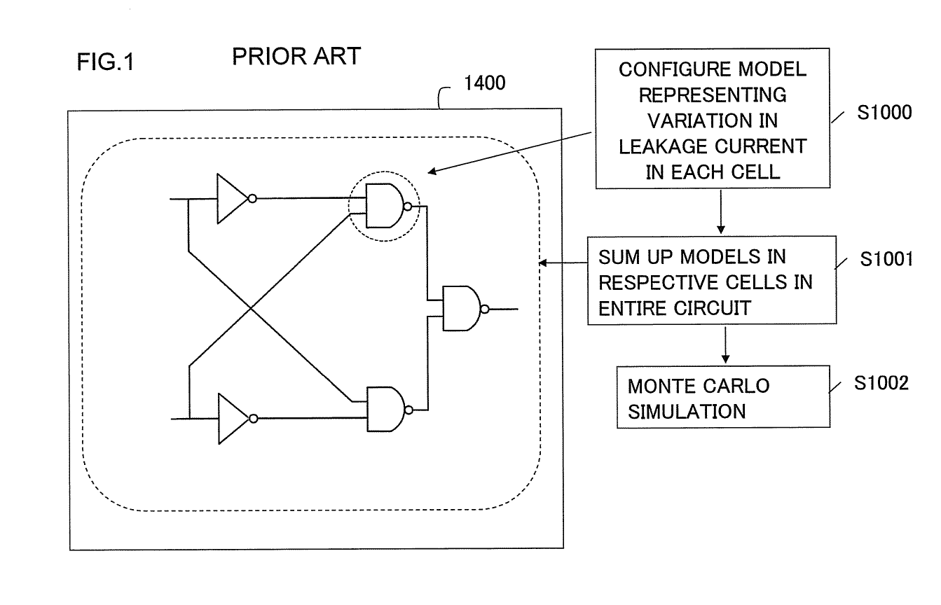

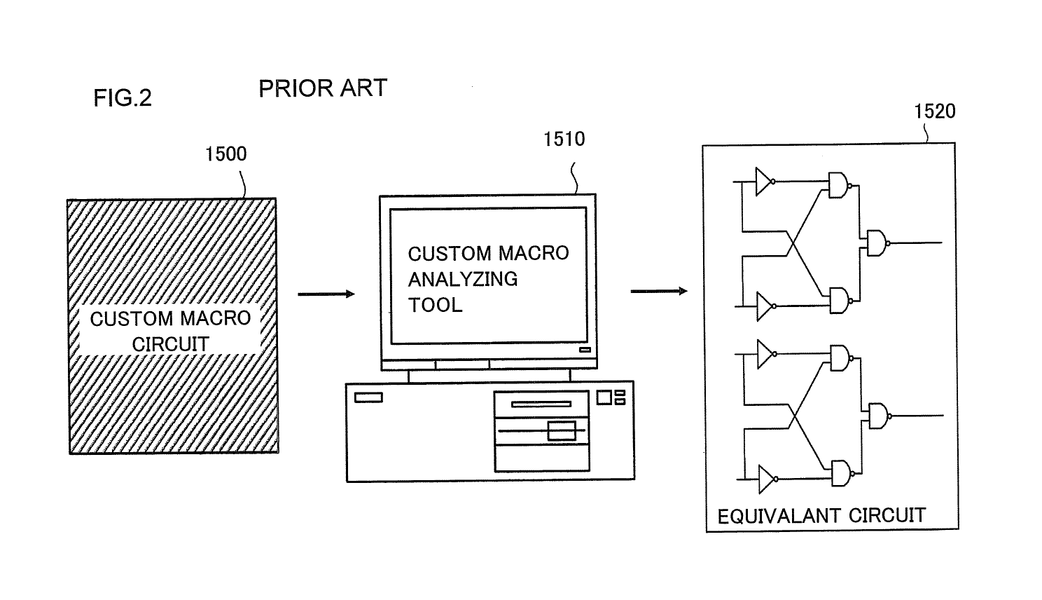

### DESCRIPTION OF EMBODIMENTS

Preferred embodiments of the program for supporting verification of leakage current distribution, the apparatus for supporting verification of leakage current distribution, and the method for supporting verification of leakage current distribution will be now described in detail with reference to the drawings. In the program for supporting verification of leakage current distribution, the apparatus for supporting verification of leakage current distribution, and the method for supporting verification of leakage current distribution, an arithmetic expression representing variations in a leakage current (hereinafter, referred to as a “leakage current model”) in an entire custom macro circuit is first configured. Secondly, from the leakage current model for the entire circuit which has been configured above, a leakage current model for each cell in the circuit is configured in consideration of independence of variations arising from each cell in the circuit. Finally, the leakage current model for each cell which has been configured above is used to calculate the leakage distribution in the entire custom macro. As a result, the leakage current distribution in the custom macro circuit, the calculation of which would have conventionally taken considerable processing time, can be determined efficiently and with high precision.

### (Overview of Support for Verification of Leakage Current Distribution)

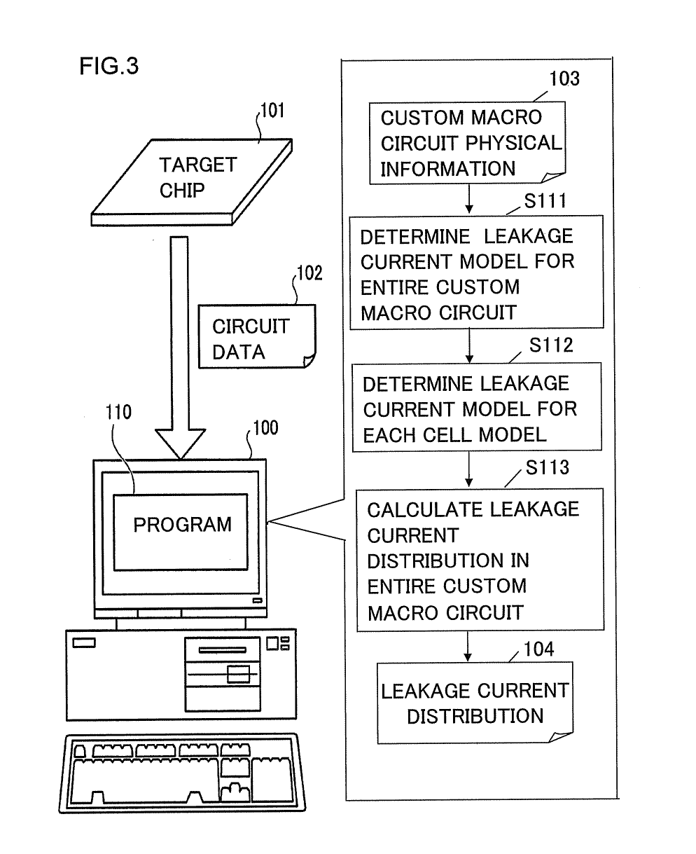

An overview of support for verification of leakage current distribution according to the present embodiment will be described first. FIG. 3 schematically illustrates the support for verification of the leakage current distribution according to the present embodiment. Referring to FIG. 3, an apparatus 100 for supporting verification of leakage current distribution according to the present embodiment includes a program 110 for supporting verification of the leakage current distribution, which is used to calculate leakage current distribution in a target chip 101 including a custom macro circuit having an unknown internal configuration.

Processes performed by the leakage current distribution verification supporting program 110 will be described in the order in which the processes are performed. First, when circuit data 102 for the target chip 101 is input, custom macro circuit physical information 103 of which leakage current distribution is verified is obtained. The custom macro circuit physical information 103 is then used to perform corner simulations a number of times, determining a leakage current model for the entire custom macro circuit (step S111).

After that, a leakage current model for each cell in the custom macro circuit is determined from the model which has been determined in step S111 (step S112). At this time, coefficients of the leakage current models of the respective cells are set in such a manner that a value of the leakage current model for the entire custom macro circuit which has been determined above becomes equal to a sum total of values of the leakage current models for respective cells.

Leakage current distribution 104 in the entire custom macro circuit is calculated from the leakage current model for each cell which has been determined in step S112 (step S113) before a series of processes is completed. The leakage current distribution 104 which has been determined in step S113 may be fed back to the leakage current distribution verification supporting apparatus 100 for setting of the target chip 101, or may be used in conjunction with an external tool for verification of the leakage current distribution.

As described above, according to the support for verification of the leakage current distribution of the present embodiment, for the custom macro circuit in which the leakage current distribution is to be verified, the leakage current model can be generated in consideration of both the variations arising from the entire custom macro circuit and the variations arising from each cell.

While the leakage current distribution 104 is calculated using the leakage current models in step S113, the calculation itself is performed using a known technique of distributing the parameter values using the Monte Carlo simulation. Therefore, it may be configured such that each of the processes up to step S112 is performed by the leakage current distribution verification supporting apparatus 100 as a unique process of supporting verification of the leakage current distribution according to the present embodiment, and that the leakage current model generated in consideration of both the variations arising from the entire circuit and the variations arising from each cell is provided to an external simulation apparatus.

### (Hardware Configuration of Leakage Current Distribution Verification Supporting Apparatus)

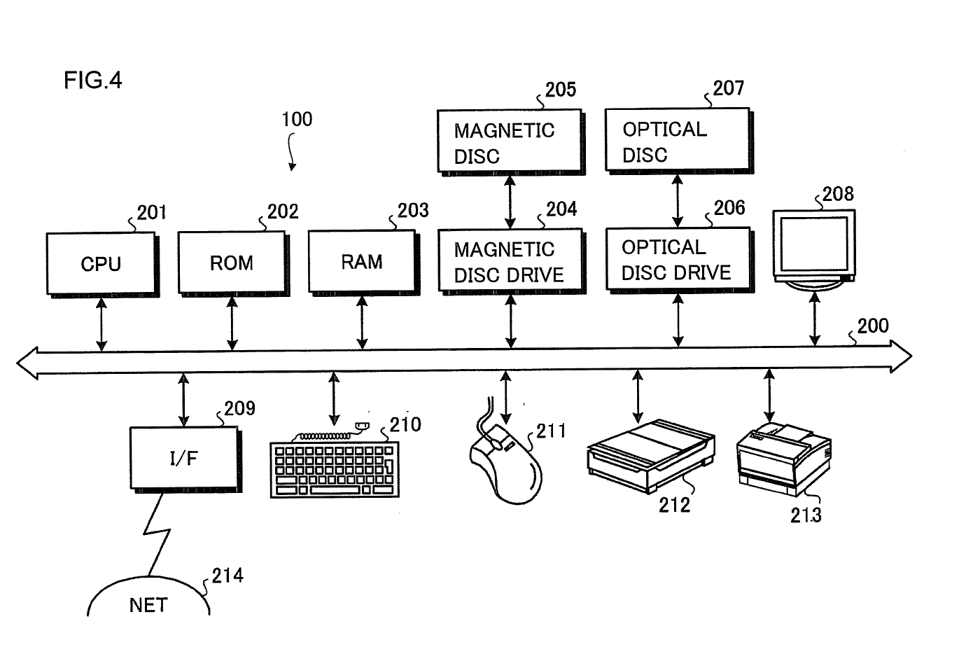

FIG. 4 is a block diagram illustrating the hardware configuration of a leakage current distribution verification supporting apparatus according to the present embodiment. Referring to FIG. 4, the leakage current distribution verification supporting apparatus 100 includes a central processing unit (CPU) 201, a read-only memory (ROM) 202, a random access memory (RAM) 203, a magnetic disk drive 204, a magnetic disk 205, an optical disk drive 206, an optical disk 207, a display 208, an interface (I/F) 209, a keyboard 210, a mouse 211, a scanner 212, and a printer 213, which are connected to each other through a bus 200.

Here, the CPU 201 is responsible for controlling the entirety of the leakage current distribution verification supporting apparatus 100. The ROM 202 stores programs such as the leakage current distribution verification supporting program and a boot program. The RAM 203 is used as a work area for the CPU 201. The magnetic disk drive 204 controls reading of data from and writing of data to the magnetic disk 205 under the control of the CPU 201. The magnetic disk 205 stores data written under the control of the magnetic disk drive 204.

The optical disk drive 206 controls reading of data from and writing of data to the optical disk 207 under the control of the CPU 201. The optical disk 207 stores data written under the control of the optical disk drive 206, and causes a computer to read data stored in the optical disk 207.

The display 208 displays not only a cursor, an icon, or a toolbox, but also a document illustrating a verification result, an image, and other data. The display 208 may be a display such as a CRT, a TFT liquid crystal display, or a plasma display.

The interface (hereinafter, referred to as the “I/F”) 209 is connected to a network 214 such as a local area network (LAN), a wide area network (WAN), or the Internet through a communication line so as to be connected to another apparatus through the network 214. The I/F 209 is responsible for interfacing between the network 214 and the inside, and controls input or output of data associated with the target chip 101, a result of verification of the leakage current distribution, and the like to or from an external apparatus. For example, the I/F 209 may be a modem or a LAN adaptor.

The keyboard 210 includes keys for inputting characters, numeric characters, various instructions, and the like, and is used for inputting data. The keyboard 210 may be an input pad or ten-key pad using a touch panel. The mouse 211 is used to move a cursor, select a range, and move or resize a window. Instead of the mouse 211, a pointing device having functions similar to those of the mouse 211, such as a trackball, a joystick, or the like, may be used.

The scanner 212 reads an image optically and stores data of the image in the leakage current distribution verification supporting apparatus 100. For the leakage current distribution verification supporting apparatus 100, the scanner 212 is mainly used for reading data by an optical character reader (OCR) function rather than just reading an image. The printer 213 prints data such as an image and a document illustrating a verification result. The printer 213 may be a laser printer or an inkjet printer.

The hardware configuration in FIG. 4 is illustrated by way of example for implementation of the leakage current distribution verification supporting apparatus 100. All pieces of the hardware described above are not necessarily included. Each piece of the hardware is not necessarily included in a single apparatus.

### (Functional Configuration of Leakage Current Distribution Verification Supporting Apparatus)

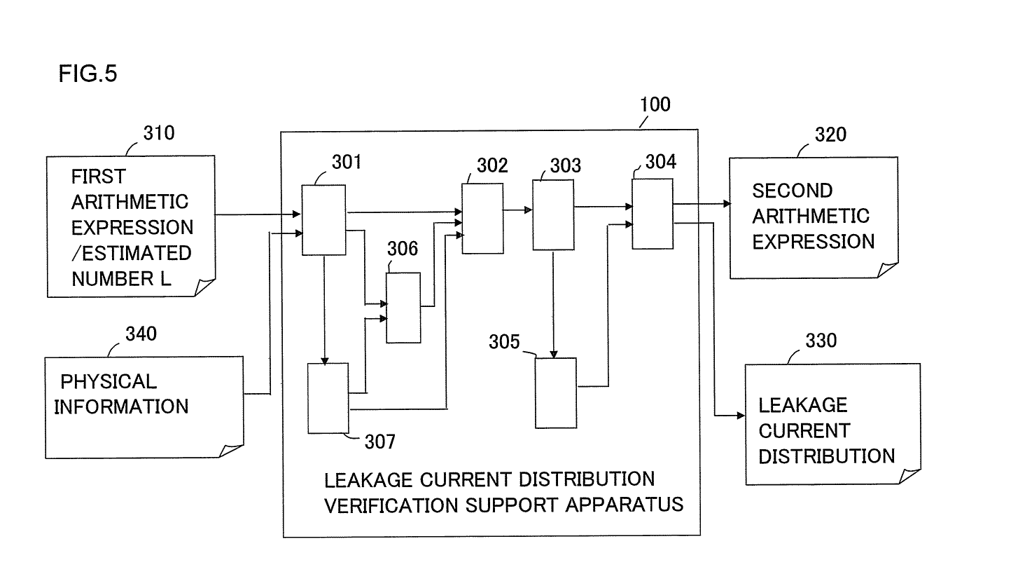

A functional configuration of the leakage current distribution verification supporting apparatus 100 will be now described. FIG. 5 is a block diagram illustrating a functional configuration of the leakage current distribution verification supporting apparatus according to the present embodiment. The leakage current distribution verification supporting apparatus 100 includes an obtaining unit 301, a generating unit 302, a setting unit 303, an outputting unit 304, a calculating unit 305, a dividing unit 306, and an analyzing unit 307. Specifically, the functions (the obtaining unit 301 through the analyzing unit 307) constituting a controlling unit may be implemented, for example, through the I/F 209, or by causing the CPU 201 to perform a program stored in a storage area such as the ROM 202, the RAM 203, the magnetic disk 205, or the optical disk 207 illustrated in FIG. 4.

The obtaining unit 301 obtains information required to verify the leakage current distribution. As will be described later specifically, the procedure for verifying the leakage current distribution by the leakage current distribution verification supporting apparatus 100 varies depending upon information obtained in the obtaining unit 301. The obtaining unit 301 may obtain information stored in advance in a storage area (such as the ROM 202, the RAM 203, the magnetic disk 205, the optical disk 207, and the like) in the leakage current distribution verification supporting apparatus 100, obtain information externally through the I/F 209, or obtain information input through the keyboard 210 or the scanner 212 by a user.

Assume that the obtaining unit 301 obtains data 310 (“first arithmetic expression and estimated number L of cells in custom macro circuit” 310) including a polynomial with a term having a common parameter α representing variations arising from each cell in the custom macro circuit and a term having a parameter β representing variations arising from the entire custom macro circuit as a leakage current model for the entire custom macro circuit.

In the case as described above, the leakage current model for the entire circuit and the estimated number L of the cells have already been prepared as the data 310. Thus, the generating unit 302 now generates a leakage current model for each cell. Specifically, the generating unit 302 generates a second arithmetic expression as the leakage current model representing variations in the leakage current in consideration of the internal configuration of the custom macro circuit, the second arithmetic expression including a polynomial with a term having a parameter αₙ (n =1, 2, . . . , L) representing, for each of the estimated number L of the cells, variations arising from the corresponding cell, the estimated number L having been obtained by the obtaining unit 301 and a term having the parameter β representing variations arising from the entire custom macro circuit (the parameter β is the same as the parameter β which has been described above).

The setting unit 303 sets coefficients in the polynomial included in the second arithmetic expression in such a manner that a result of calculation of the second arithmetic expression generated in the generating unit 302 becomes equal to a result of calculation of the first arithmetic expression obtained by the obtaining unit 301.

The outputting unit 304 outputs a second arithmetic expression 320 in which the coefficients have been set by the setting unit 303, as the leakage current model for use in verification of the leakage current distribution in the custom macro circuit. That is, the leakage current model in consideration of variations arising from both the entire circuit and each cell is output. As described above, while only the second arithmetic expression 320 may be output, if it is desired to calculate the leakage current distribution in the leakage current distribution verification supporting apparatus 100 as well, the calculating unit 305 may also be used.

The calculating unit 305 calculates leakage current distribution 330 of the custom macro circuit from a result of a leakage current distribution simulation in the custom macro circuit which is performed on the basis of the second arithmetic expression 320 in which the coefficients have been set by the setting unit 303. Specifically, the leakage current distribution 330 of the custom macro circuit may be calculated by performing the Monte Carlo simulation of the leakage current distribution in the custom macro circuit using the second arithmetic expression 320. When the leakage current distribution 330 has been calculated by the calculating unit 305 as described above, the leakage current distribution 330 is output from the outputting unit 304.

In the procedure described above, the custom macro circuit included in the target chip 101 is processed as a single unit. However, the process may result in a bottleneck due to a large processing load caused by thousands or more cells which are actually included in the custom macro circuit. Therefore, the custom macro circuit is able to be divided into a plurality of partial circuits to reduce respective processing loads.

When the process is performed for each of the partial circuits, the obtaining unit 301 obtains, for each of the partial circuits into which the custom macro circuit is divided, the leakage current model and an estimated number L of cells included therein. Correspondingly, the generating unit 302 generates the second arithmetic expression for each partial circuit. The setting unit 303 sets coefficients in the polynomial included in the second arithmetic expression in such a manner that a result of calculation of the second arithmetic expression for each partial circuit becomes equal to a result of calculation of the current model for the partial circuit, which has been obtained by the obtaining unit 301. When the obtaining unit 301 obtains physical information 340 about wiring of the custom macro circuit, the custom macro circuit may be converted into a plurality of partial circuits in the dividing unit 306.

When the obtaining unit 301 has obtained the physical information about the wiring of the custom macro circuit, the dividing unit 306 uses the physical information 340 to divide the custom macro circuit into a plurality of partial circuits. Specifically, the custom macro circuit may be divided into partial circuits by functions on the basis of hierarchy information obtained from the physical information 340, or into partial circuits in units of a predetermined number of cells on the basis of the physical information 340. For the partial circuits into which the custom macro circuit has been divided as described above, the leakage current model is generated for each cell in the circuit, and the leakage current models for respective cells are combined with each other to generate the leakage current model for the custom macro circuit (the second arithmetic expression), as with the processing of the entire custom macro circuit described above.

The obtaining unit 301 may obtain the circuit data 102 of the custom macro circuit in which no leakage current model has been generated. Specifically, the circuit data 102 is the physical information 340 about the wiring of the custom macro circuit. In this case, the analyzing unit 307 is used. When the obtaining unit 301 has received the physical information 340 of the custom macro circuit, the analyzing unit 307 uses the physical information 340 to generate the leakage current model for the custom macro circuit and to determine the estimated number L of cells in the custom macro circuit.

The leakage current model for the custom macro circuit and the estimated number L, which have been generated in the analyzing unit 307, are output to the generating unit 302, and used for generation of the second arithmetic expression 320 through the processes similar to those performed in relation with the “first arithmetic expression and estimated number L of cells in custom macro circuit” 310 as described above.

As described above, according to the leakage current distribution verification supporting apparatus 100 of the present embodiment, the processing for generating the second arithmetic expression 320 is carried out through required functional units in accordance with the state of the information (310 and/or 340) obtained in the obtaining unit 301. Further, according to the leakage current distribution verification supporting apparatus 100, the state of the information (320 and/or 330) to be output from the outputting unit 304 can be selected as appropriate in accordance with an instruction from a user. Hereinafter, first and second embodiments will be described as specific examples of the processing procedure for supporting verification of leakage current distribution in the leakage current distribution verification supporting apparatus 100 having the configuration described above.

### First Embodiment

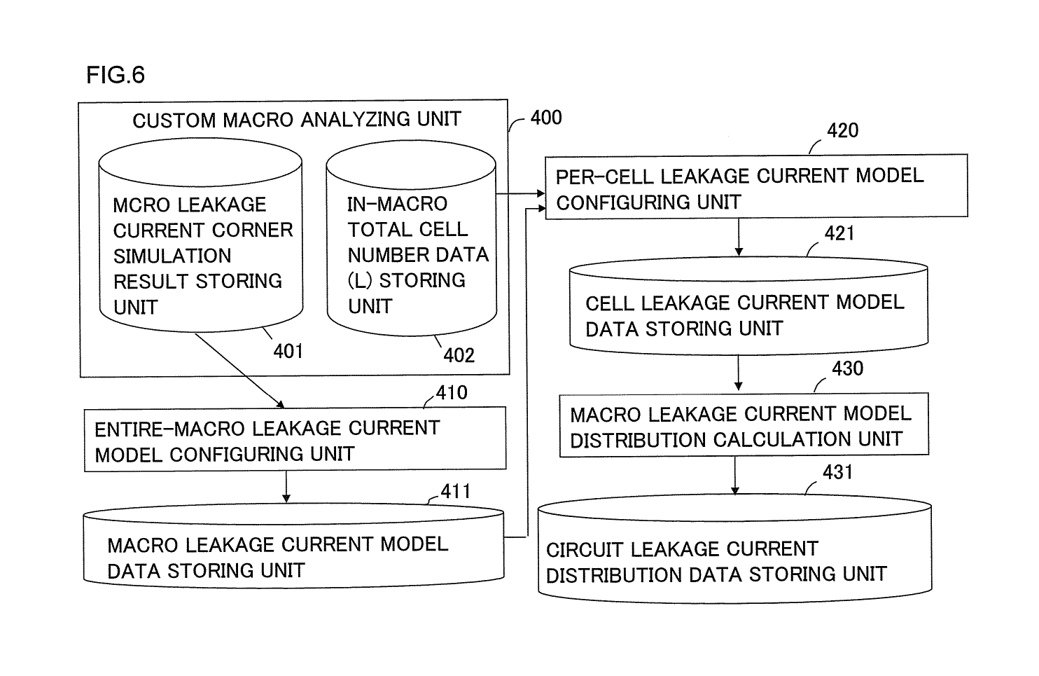

According to the first embodiment, verification of the leakage current distribution is supported for each custom macro circuit included in the target chip 101 of which the leakage current distribution is to be verified. FIG. 6 is a block diagram illustrating the configuration of a leakage current distribution verification supporting apparatus according to the first embodiment. Referring to FIG. 6, in the first embodiment, the processes performed can be classified primarily as a custom macro analyzing unit 400, an entire-macro leakage current model configuring unit 410, a per-cell leakage current model configuring unit 420, and a macro leakage current distribution calculating unit 430.

The custom macro analyzing unit 400 corresponds to the processing performed in the analyzing unit 307 described above in conjunction with FIG. 5. This is a preparatory process for generating the leakage current model, in which a corner simulation of the custom macro circuit is performed in order to determine the leakage current model and the estimated number L of cells in the custom macro circuit using the physical information of the target chip 101.

The corner simulation is a technique known to the public. Thus, detailed description thereof will not be provided here. In the present embodiment, for example, a tool such as Star-RCXT, available from Synopsys, Inc., is used. Simple procedures will be now described. Transistors as well as capacitance and resistance in the custom macro circuit are first extracted on the basis of physical information including wiring information of the custom macro circuit, so as to create a netlist as an equivalent circuit. The netlist is a file in which elements and connections between the elements in a circuit are described. The estimated number L of cells in the custom macro circuit can be determined from the number of transistors extracted here. The estimated number L which has been determined is stored in an in-macro total cell number data (L) storing unit 402.

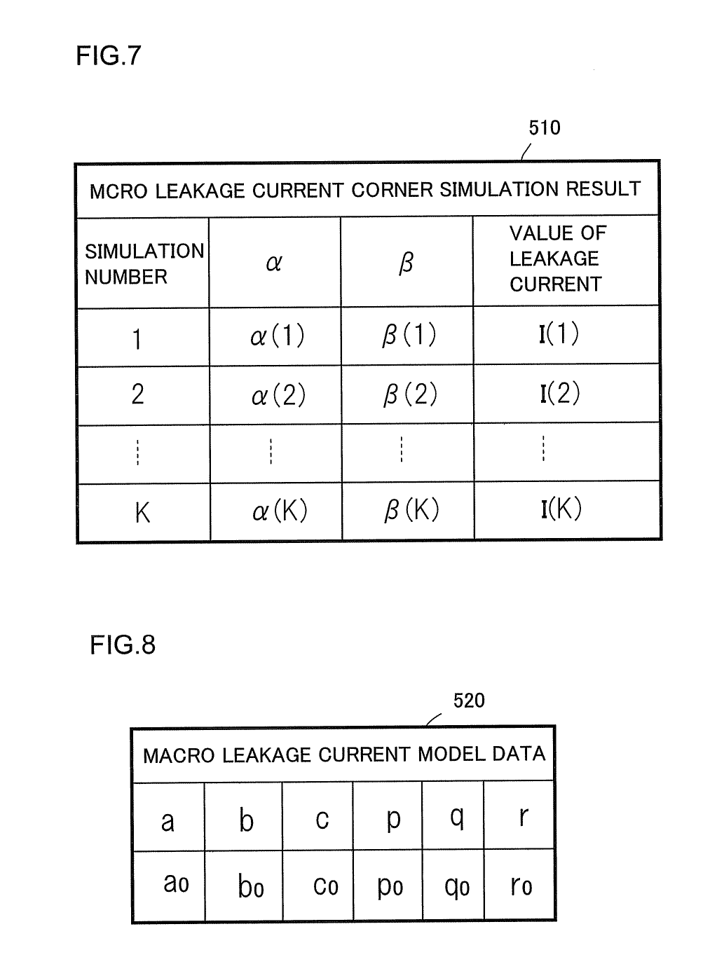

The netlist created as described above is subjected to the corner simulation, which is performed by a simulation program such as SPICE. The results of the simulation are stored in a macro leakage current corner simulation result storing unit 401. FIG. 7 is a table illustrating by way of example a format of data regarding a result of a macro leakage current corner simulation. The result of the macro leakage current corner simulation determined by the custom macro analyzing unit 400 is stored in the form of a table 510. The table 510 illustrates the case where the corner simulations have been performed K times.

The entire-macro leakage current model configuring unit 410 performs the function of the analyzing unit 307 described above in conjunction with FIG. 5. That is, the entire-macro leakage current model configuring unit 410 uses the result of the macro leakage current corner simulation to configure a leakage current model for the entire custom macro circuit as expressed by the following expression (2). The macro leakage current model configured by the entire-macro leakage current model configuring unit 410 is stored in a macro leakage current model data storing unit 411.

The macro leakage current model can be represented as the following expression (2).

exp(a+b*α+c*β+p*α²+q*α*β+r*β²) (2)

FIG. 8 is a table illustrating by way of example a format of data regarding the macro leakage current model. The entire-macro leakage current model configured by the entire-macro leakage current model configuring unit 410 is stored in the form of a table 520 illustrating a value of each coefficient included in the above expression (2). Generally, a parameter α represents variations arising from cells, and a parameter β represents variations arising from the entire custom macro circuit. This means that the parameter α is supposed to be independent for each cell. In the above expression (2), however, the parameter α is common and the independence of α for each cell has been ignored.

In view of the foregoing, the leakage current model for each cell is then configured by the per-cell leakage current model configuring unit 420. The per-cell leakage current model configuring unit 420 performs the functions of the generating unit 302 and the setting unit 303 which have been described above. That is, the per-cell leakage current model configuring unit 420 uses the entire-macro leakage current model which has been configured by the entire-macro leakage current model configuring unit 410 to configure the leakage current model for each cell. Specifically, the coefficients are set in such a manner that the entire-macro leakage current model becomes equal to a sum total of the leakage current models for respective cells, as expressed by the following expression (3).

$$exp ( a + b * α + c * β + p * {α}^{2} + q * α * β + r * {β}^{2} ) = exp ( {a}_{1} + {b}_{1} * {α}_{1} + {c}_{1} * β + {p}_{1} * {α}_{1}^{2} + {q}_{1} * {α}_{1} * β + {r}_{1} * {β}^{2} ) + exp ( {a}_{2} + {b}_{2} * {α}_{2} + {c}_{2} * β + {p}_{2} * {α}_{2}^{2} + {q}_{2} * {α}_{2} * β + {r}_{2} * {β}^{2} ) + … + exp ( {a}_{n} + {b}_{n} * {α}_{n} + {c}_{n} * β + {p}_{n} * {α}_{n}^{2} + {q}_{n} * {α}_{n} * β + {r}_{n} * {β}^{2} ) \\ n = 1 , 2 , … , L \qquad ( 3 )$$

For setting the leakage current model for each cell, various arithmetic tools may be used. Alternatively, taking advantage of the tendency that cells having various coefficients are distributed evenly in the custom macro circuit, coefficients satisfying the above expression (3) may be set by assuming that the leakage current model for each cell equally becomes 1/L of the entire-macro leakage current model. In this case, the sum total of the leakage current model for each cell can be represented as the following expression (4).

exp(a−log (L)+b*αᵢ+c*β+p*αᵢ²+q*αᵢ*β+r*β²) (4)

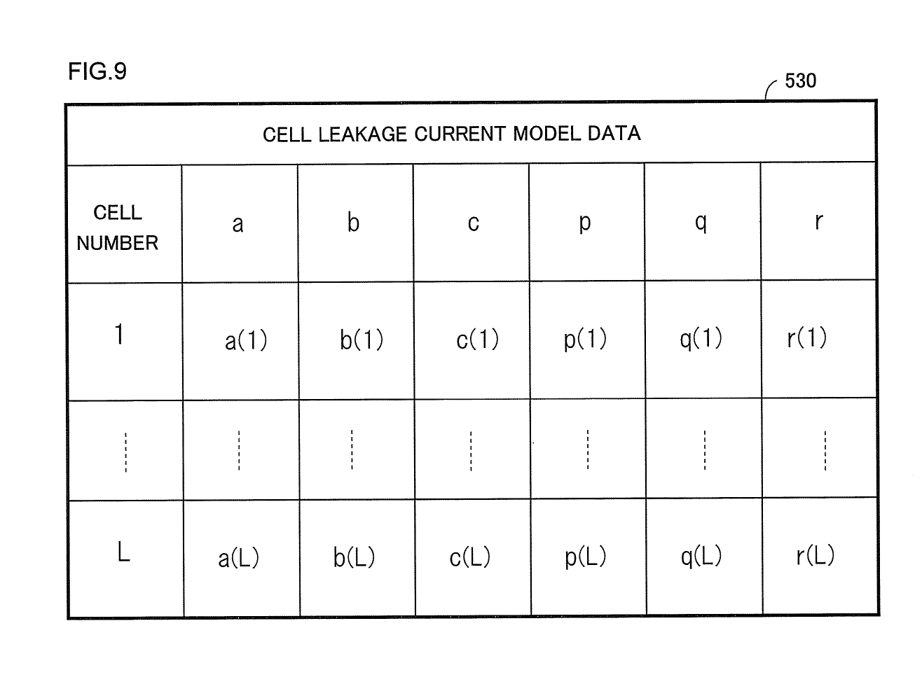

The cell leakage current model for each cell which has been configured by the per-cell leakage current model configuring unit 420 is stored in the cell leakage current model data storing unit 421. FIG. 9 is a table illustrating by way of example a format of data regarding the cell leakage current model. In the cell leakage current model data storing unit 421, the cell leakage current model for each cell is stored in the form of a table 530 which illustrates, for each cell, a value for each of the coefficients included in the above expression (3).

The macro leakage current distribution calculating unit 430 performs the function of the calculating unit 305 described above. That is, the macro leakage current distribution calculating unit 430 uses the cell leakage current model for each cell stored in the cell leakage current model data storing unit 421, to calculate the macro leakage current distribution. The macro leakage current distribution calculating unit 430 calculates the custom macro circuit leakage current distribution by causing values of the parameters αₙ (n=1, 2, . . . , L) and β included in the above expression (3) to be distributed, by using the Monte Carlo simulation.

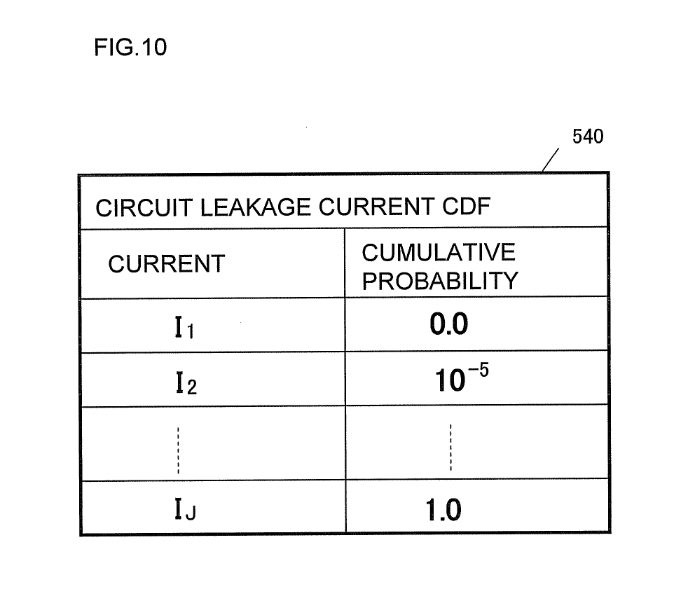

The macro leakage current distribution calculated by the macro leakage current distribution calculating unit 430 is stored in the circuit leakage current distribution data storing unit 431. FIG. 10 is a table illustrating by way of example a format of data regarding a circuit leakage current CDF. The circuit leakage current distribution data storing unit 431 stores a table 540 representing a graph of a discretized leakage cumulative probability distribution function (CDF) which has been performed by the macro leakage current distribution calculating unit 430.

### <Procedure of Processing for Supporting Verification of Leakage Current Distribution According to the First Embodiment>

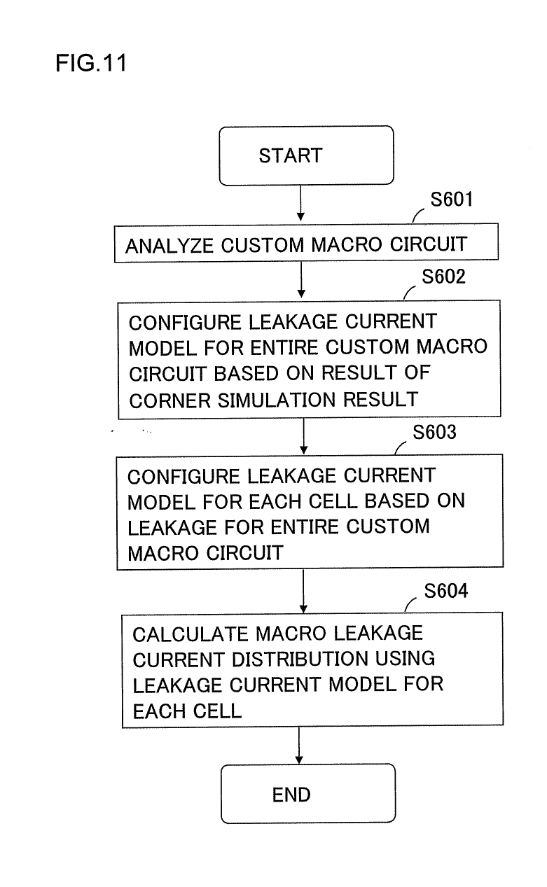

Now, a procedure of processing for supporting verification of leakage current distribution in the above-described configuration will be described. FIG. 11 is a flowchart illustrating the procedure of the processing for supporting verification of the leakage current distribution according to the first embodiment. Referring to the flowchart in FIG. 11, the custom macro circuit in the target chip 101 is first analyzed (step S601). Specifically, the analysis of the custom macro circuit includes the entire-macro leakage current corner simulation performed by the custom macro analyzing unit 400, and processing for estimation of the total number L of cells in the custom macro circuit.

The leakage current model for the entire custom macro circuit is now configured on the basis of a result of the leakage current corner simulation (step S602). After that, the leakage current model for each cell is configured on the basis of the leakage current model for the entire custom macro circuit (step S603). Finally, macro leakage current distribution is calculated using the leakage current model for each cell (step S604), before a series of processes is completed.

### Second Embodiment

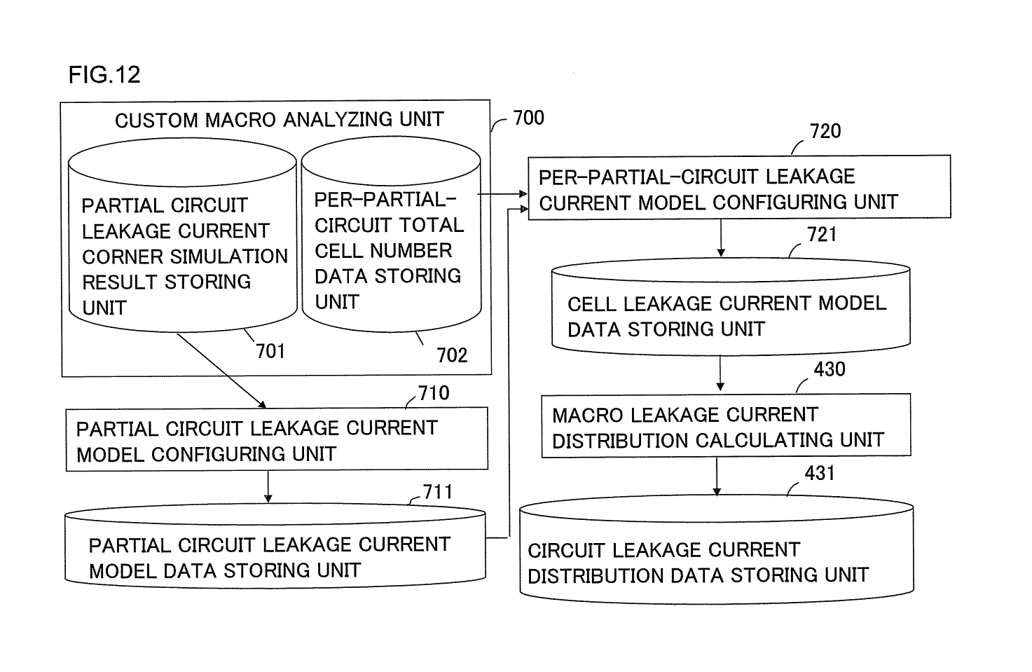

According to the second embodiment, the custom macro circuit included in the target chip 101 of which the leakage current distribution is to be verified is further divided into a plurality of partial circuits to generate the leakage current model for each partial circuit. FIG. 12 is a block diagram illustrating the configuration of a leakage current distribution verification supporting apparatus according to the second embodiment. Referring to FIG. 12, in the second embodiment, the processes performed can be classified primarily as a custom macro analyzing unit 700, a partial circuit leakage current model configuring unit 710, a per-partial-circuit leakage current model configuring unit 720, and a macro leakage current distribution calculating unit 430.

The custom macro analyzing unit 700 performs the functions of the dividing unit 306 and the analyzing unit 307 described above in conjunction with FIG. 5. That is, the custom macro analyzing unit 700 carries out the leakage current corner simulation for each of the partial circuits into which the custom macro circuit has been divided. The results of the simulation are stored in a partial circuit leakage current corner simulation result storing unit 701. Further, an estimated number of cells in a partial circuit per partial circuit are stored in a per-partial-circuit total cell number data storing unit 702.

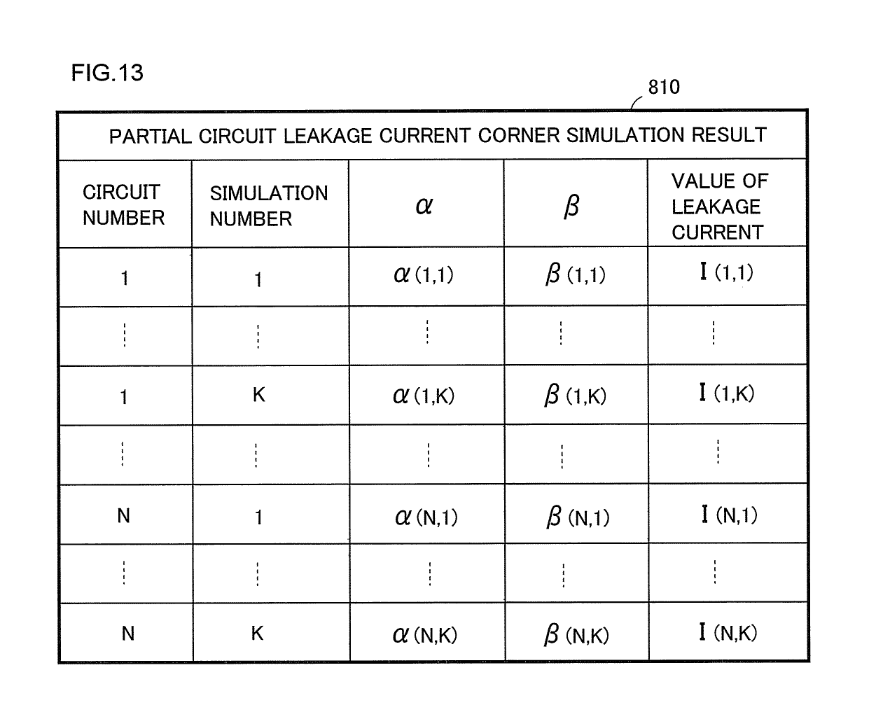

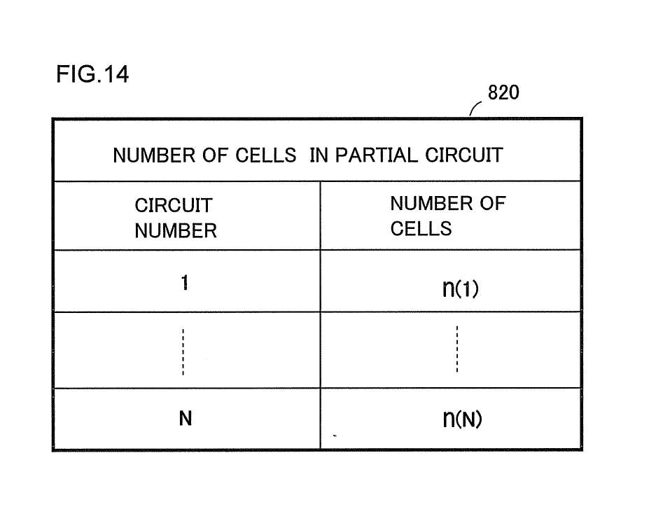

FIG. 13 is a table illustrating by way of example a format of data regarding a result of a partial circuit leakage current corner simulation. FIG. 14 is a table illustrating by way of example a format of data regarding the number of cells in the partial circuit. The result of the partial circuit leakage current corner simulation determined by the custom macro analyzing unit 700 is stored in the form of the table 810. The result of the partial circuit leakage current corner simulation determined by the custom macro analyzing unit 700 is stored in the form of a table 810. The estimated number of cells which have been determined is stored in the form of a table 820.

The partial circuit leakage current model configuring unit 710 performs the function of the analyzing unit 307 described in conjunction with FIG. 5. That is, the partial circuit leakage current model configuring unit 710 uses the result of the partial circuit leakage current corner simulation to configure a leakage current model for the entire partial circuit. The partial circuit leakage current model configured by the partial circuit leakage current model configuring unit 710 is stored in a partial circuit leakage current model data storing unit 711. The partial circuit leakage current model can be represented as the following expression (5).

exp(a₁+b₁* α+c₁*β+p₁*α²+q₁*α*β+r₁*β²), . . . , exp(a_{N}+b_{N}*α+c_{N}*β+p_{N}*α²+q_{N}*α*β+r_{N}*β²) (5)

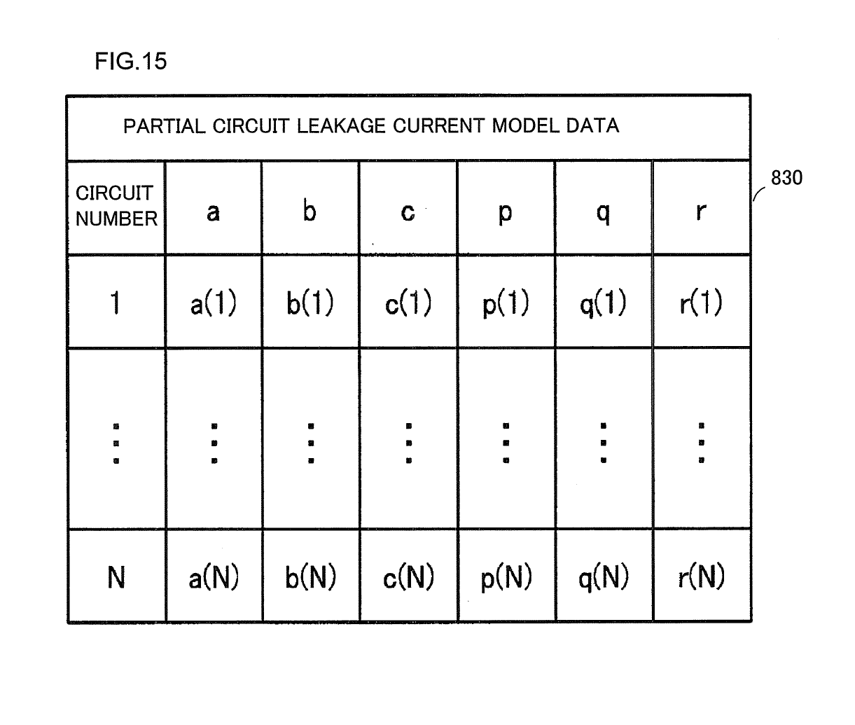

FIG. 15 is a table illustrating by way of example a format of data regarding the partial circuit leakage current model. The partial circuit leakage current model configured by the partial circuit leakage current model configuring unit 710 is stored in the form of a table 830 which illustrates the values of coefficients for each partial circuit.

Then, as in the case of the first embodiment, the leakage current model for each cell is configured from the leakage current model for the entirety by the per-partial-circuit leakage current model configuring unit 720. In the second embodiment, however, the leakage current model for each cell is configured from the leakage current model for the entirety, per partial circuit. A cell leakage current model for each cell configured by the per-partial-circuit leakage current model configuring unit 720 is stored in a cell leakage current model data storing unit 721.

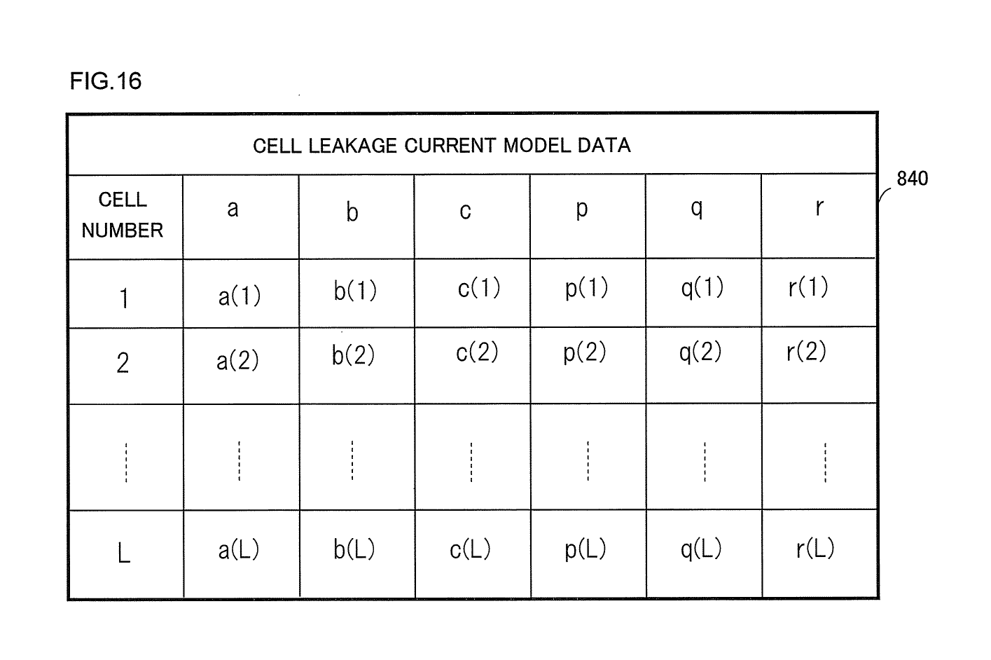

FIG. 16 is a table illustrating by way of example a format of data regarding the cell leakage current model. In the cell leakage current model data storing unit 721, the cell leakage current model for each cell is stored in the form of a table 840 illustrating, for each cell, a value of each of the coefficients included in the expression (3). The cell leakage current model for each cell stored in the table 840 macro leakage current distribution is calculated by the macro leakage current distribution calculating unit 430 which has been described in the first embodiment. The macro leakage current distribution which has been calculated is stored in the circuit leakage current distribution data storing unit 431.

### <Procedure of Processing for Supporting Verification of Leakage Current Distribution According to the Second Embodiment>

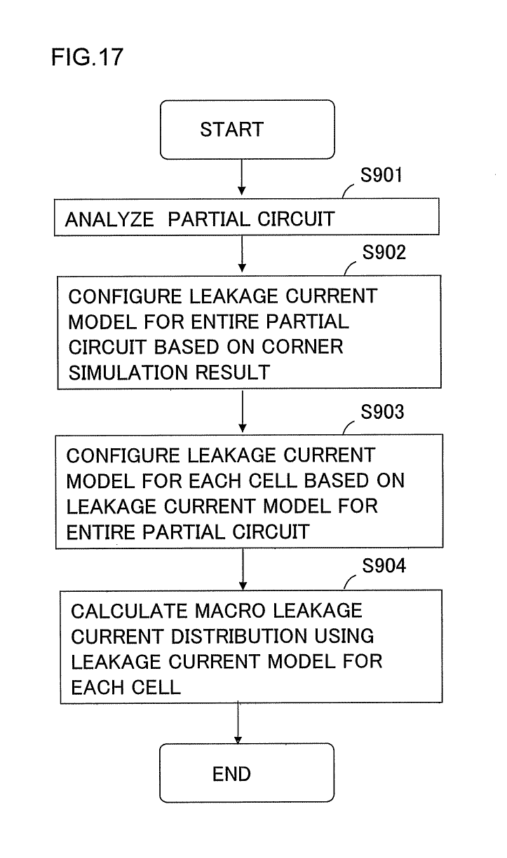

Now, a procedure of processing for supporting verification of leakage current distribution in the above-described configuration will be described. FIG. 17 is a flowchart illustrating the procedure of the processing for supporting verification of the leakage current distribution according to the second embodiment. Referring to the flowchart in FIG. 17, the partial circuit of the custom macro circuit in the target chip 101 is first analyzed (step S901).

The leakage current model for the entire partial circuit is then configured on the basis of a result of the leakage current corner simulation (step S902). After that, the leakage current model for each cell is configured on the basis of the leakage current model for the entire partial circuit (step S903). Finally, macro leakage current distribution is calculated using the leakage current model for each cell (step S904), before a series of processes is completed.

As described above, either of the first embodiment or the second embodiment can be used depending upon the scale of a custom macro circuit to be verified. Hereinafter, examples of processing of the leakage current model for the entirety which has been described above, the leakage current model for each cell, and the leakage current distribution using the leakage current model in which a coefficient is set will be described. Although the information used in the second embodiment will be used as input and output values in the following, the information used in the first embodiment can be also appropriately used.

### (Process of Model Formula Fitting)

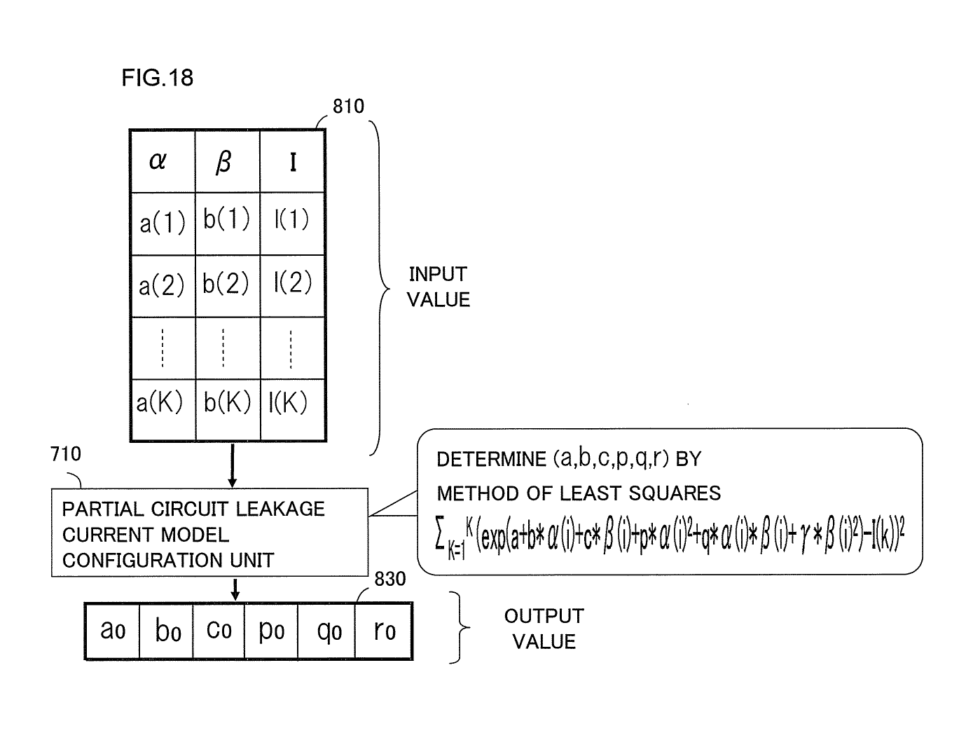

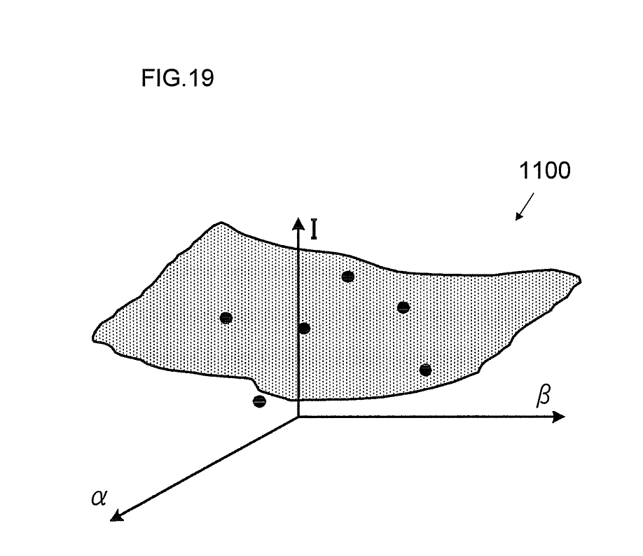

First, a procedure of configuring the leakage current model for the entirety in steps S602 and S902 will be described. FIG. 18 illustrates a process of model formula fitting. FIG. 19 illustrates by way of example a model of the leakage current distribution in the partial circuit. Here, for a model formula representing the leakage current model for the entirety, parameters can be made to be distributed in accordance with a result of simulation (table 1100), and coefficients (a, b, c, p, q, r) can be determined by using the least squares method.

### (Process of Configuring Leakage Current Model)

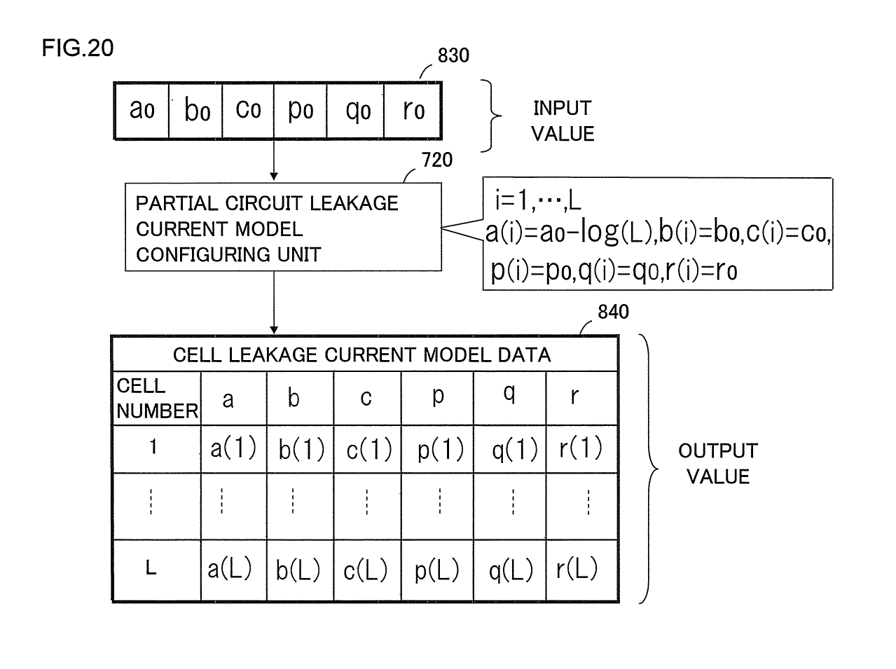

Second, a process of configuring the leakage current model for each cell in steps S603 and S903 will be described. FIG. 20 illustrates a process of configuring the leakage current model for each cell.

The per-partial-circuit leakage current model configuring unit 720 sets coefficients in such a manner that the sum total of each of the coefficients for each of 1 to L (estimated number) becomes 1/L of the leakage current model for the entirety.

### (Process of Calculating Macro Leakage Current Distribution)

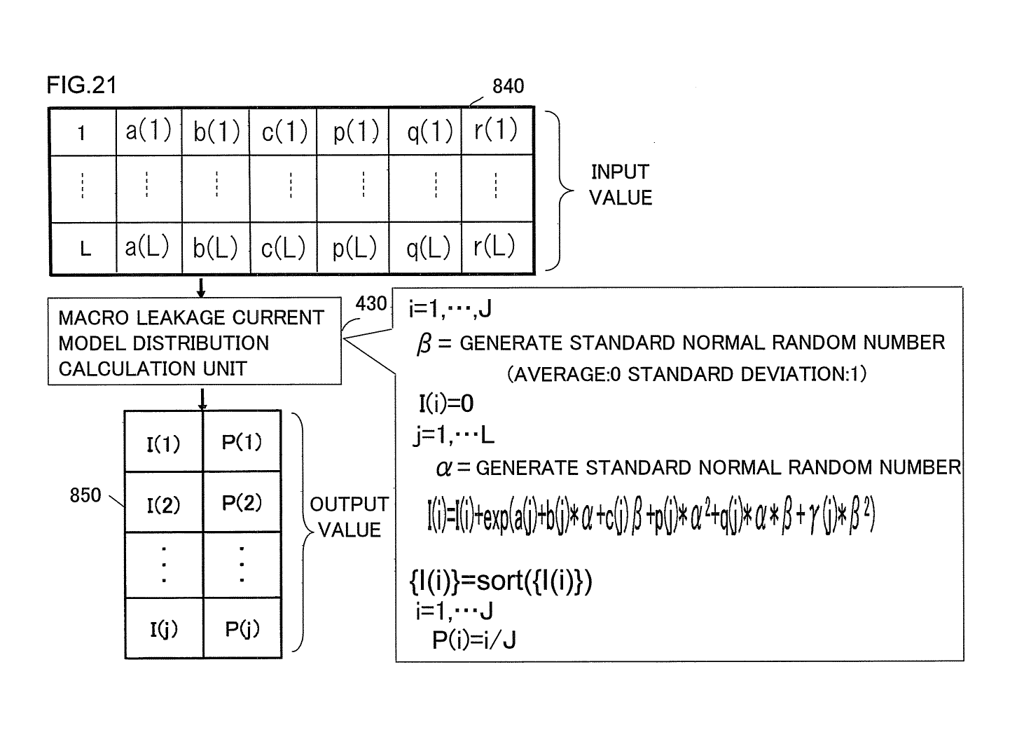

Third, a process of calculating the macro leakage current distribution will be described with an example. FIG. 21 illustrates a process of calculating the macro leakage current distribution using the Monte Carlo simulation. As illustrated in FIG. 21, the macro leakage current distribution calculating unit 430 calculates the macro leakage current distribution by causing values of the parameters α and β to be distributed by using the Monte Carlo simulation.

As described above, according to the present embodiment, the leakage current model for the entire custom macro is output, in consideration of the influences of the variations specific to each cell in the custom macro circuit. The Monte Carlo simulation is performed a predetermined number of times so that parameters (αₙ, β) in a polynomial included in the leakage current model output here are evenly distributed. Then, the result of the Monte Carlo simulation can be used to determine the leakage current distribution for the entire custom macro circuit in consideration of variations specific to each cell. By applying the processing of supporting verification of the leakage current distribution according to the present embodiment, the leakage current distribution can be verified efficiently and with high precision, even in a custom macro circuit having an unknown internal configuration.

It is noted that the method for supporting verification of leakage current distribution described in the present embodiment can be implemented by performing, in a computer such as a personal computer or a workstation, a program which has been prepared in advance. The program is stored in advance in a computer-readable recording medium, such as a hard disk, a flexible disk, a CD-ROM, an MO, a DVD, and the like, and read from the recording medium by a computer for execution. The program may be stored in a medium which can be distributed through a network such as the Internet.

The leakage current distribution verification supporting apparatus 100 described in the present embodiment can also be implemented by an application specific integrated circuit (hereinafter, simply referred to as an “ASIC”) such as a standard cell and a structured ASIC, or a programmable logic device (PLD) such as an FPGA. Specifically, for example, the leakage current distribution verification supporting apparatus 100 can be manufactured by defining the above-described functions (the obtaining unit 301 through the analyzing unit 307) of the leakage current distribution verification supporting apparatus 100 by HLD descriptions, and by logically synthesizing the HLD descriptions to provide the same to an ASIC or a PLD.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A computer readable storage medium storing a leakage current distribution verification program for causing a computer to execute:
obtaining a first arithmetic expression and an estimated number L of cells in a custom macro circuit, the first arithmetic expression being an arithmetic expression representing variations in a leakage current in the custom macro circuit having an unknown internal configuration, the first arithmetic expression including a polynomial with a term having a common parameter α representing variations arising from each cell in the custom macro circuit and with a term having a parameter β representing variations arising from the entirety of the custom macro circuit;
generating a second arithmetic expression, as an arithmetic expression representing variations in the leakage current in consideration of an internal configuration of the custom macro circuit, the second arithmetic expression including a polynomial with a term having a parameter αₙ (n=1, 2, . . . , L) and a term having the parameter β, the parameter αₙ representing variations arising from each of the estimated number L of the cells, the estimated number L having been obtained by the obtaining procedure;
setting coefficients in the polynomial included in the second arithmetic expression in such a manner that a result of calculation of the second arithmetic expression generated by the generating procedure becomes equal to a result of calculation of the first arithmetic expression obtained by the obtaining procedure; and
outputting the second arithmetic expression in which the coefficients have been set by the setting procedure, as an arithmetic expression for use in verification of leakage current distribution in the custom macro circuit.

2. The computer readable storage medium according to claim 1, the program further causing the computer to execute:
calculating the leakage current distribution in the custom macro circuit from a result of simulation of a leakage current distribution in the custom macro circuit performed by using the second arithmetic expression in which coefficients have been set by the setting procedure, wherein
the outputting procedure further outputs the leakage current distribution calculated by the calculating procedure.

3. The computer readable storage medium according to claim 2, wherein the calculating procedure calculates the leakage current distribution in the custom macro circuit by performing the Monte Carlo simulation of the leakage current distribution in the custom macro circuit using the second arithmetic expression in which the coefficients have been set by the setting procedure.

4. The computer readable storage medium according to claim 1, wherein, in the case where the obtaining procedure obtains the first arithmetic expression for each of partial circuits into which the custom macro circuit has been divided and also obtains the estimated number L of cells in each of the partial circuits, the generating procedure generates the second arithmetic expression for each of the partial circuits, wherein
the setting procedure sets coefficients in the polynomial included in the second arithmetic expression for each of the partial circuits in such a manner that a result of calculation of the second arithmetic expression for each of the partial circuits generated by the generating procedure becomes equal to a result of calculation of the first arithmetic expression for each of the partial circuits obtained by the obtaining procedure.

5. The computer readable storage medium according to claim 4, wherein the obtaining procedure obtains, for each of the partial circuits into which the custom macro circuit has been divided in accordance with functions thereof, the first arithmetic expression and the estimated number L of cells in the partial circuits.

6. The computer readable storage medium according to claim 4, wherein the obtaining procedure obtains, for each of the partial circuits into which the custom macro circuit has been divided in units of a predetermined number of cells in the custom macro circuit, the first arithmetic expression and the estimated number L of cells in the partial circuits.

7. The computer readable storage medium according to claim 1, the program further causing the computer to execute:
a macro analyzing procedure for determining the first arithmetic expression and the estimated number L of cells in the custom macro circuit by using physical information about wiring in the custom macro circuit in the case where the obtaining procedure receives the physical information, wherein
the generating procedure generates the second arithmetic expression including the polynomial with a term having a parameter αₙ (n=1, 2, . . . , L) and a term having the parameter β, the parameter αₙ representing, for each of the estimated number L of the cells, variations arising from the corresponding cell, the estimated number L having been determined by the macro analyzing procedure, and
the setting procedure sets the coefficients in the polynomial included in the second arithmetic expression in such a manner that a result of calculation of the second arithmetic expression generated by the generating procedure becomes equal to a result of calculation of the first arithmetic expression determined by the macro analyzing procedure.

8. The computer readable storage medium according to claim 7, the program further causing the computer to execute:
dividing the custom macro circuit into a plurality of partial circuits by using the physical information about the wiring in the custom macro circuit in the case where the obtaining procedure receives the physical information, wherein
the macro analyzing procedure determines, for each of the partial circuits into which the custom macro circuit has been divided by the dividing procedure, the first arithmetic expression and the estimated number L of cells in the partial circuit.

9. The computer readable storage medium according to claim 8, wherein the dividing procedure divides the custom macro circuit into the partial circuits in accordance with functions on the basis of hierarchy information obtained from the physical information about the custom macro circuit which has been obtained by the obtaining procedure.

10. The computer readable storage medium according to claim 8, wherein the dividing procedure divides the custom macro circuit into the partial circuits in units of the predetermined number of cells, on the basis of the physical information about the custom macro circuit which has been obtained by the obtaining procedure.

11. The computer readable storage medium according to claim 7, wherein, in the case where the obtaining procedure obtains the physical information about the custom macro circuit, the macro analyzing procedure further includes
creating for creating a netlist of the custom macro circuit using the physical information,
simulating for performing an operating simulation of the netlist created by the creating procedure, and
determining the first arithmetic expression and the estimated number L of cells in the custom macro circuit by using a result of the simulation performed by the simulating procedure.

12. A method for supporting verification of leakage current distribution, the method comprising:
obtaining a first arithmetic expression and an estimated number L of cells in a custom macro circuit, the first arithmetic expression being an arithmetic expression representing variations in a leakage current in the custom macro circuit having an unknown internal configuration, the first arithmetic expression including a polynomial with a term having a common parameter α representing variations arising from each cell in the custom macro circuit and with a term having a parameter β representing variations arising from the entirety of the custom macro circuit;
generating a second arithmetic expression, as an arithmetic expression representing variations in the leakage current in consideration of an internal configuration of the custom macro circuit, the second arithmetic expression including a polynomial with a term having a parameter αₙ (n=1, 2, . . . , L) and a term having the parameter β, the parameter αₙ representing variations arising from each of the estimated number L of the cells, the estimated number L having been obtained by the obtaining process;
setting coefficients in the polynomial included in the second arithmetic expression in such a manner that a result of calculation of the second arithmetic expression generated by the generating means becomes equal to a result of calculation of the first arithmetic expression obtained by the obtaining process; and
outputting the second arithmetic expression in which the coefficients have been set by the setting process, as an arithmetic expression for use in verification of leakage current distribution in the custom macro circuit.

13. An apparatus for supporting verification of leakage current distribution, the apparatus comprising:
obtaining unit a first arithmetic expression and an estimated number L of cells in a custom macro circuit, the first arithmetic expression being an arithmetic expression representing variations in a leakage current in the custom macro circuit having an unknown internal configuration, the first arithmetic expression including a polynomial with a term having a common parameter α representing variations arising from each cell in the custom macro circuit and with a term having a parameter β representing variations arising from the entirety of the custom macro circuit;
generating unit for generating a second arithmetic expression, as an arithmetic expression representing variations in the leakage current in consideration of an internal configuration of the custom macro circuit, the second arithmetic expression including a polynomial with a term having a parameter αₙ (n=1, 2, . . . , L) and a term having the parameter β, the parameter αₙ representing variations arising from each of the estimated number L of the cells, the estimated number L having been obtained by the obtaining unit;
setting unit for setting coefficients in the polynomial included in the second arithmetic expression in such a manner that a result of calculation of the second arithmetic expression generated by the generating unit becomes equal to a result of calculation of the first arithmetic expression obtained by the obtaining unit; and
outputting unit for outputting the second arithmetic expression in which the coefficients have been set by the setting unit, as an arithmetic expression for use in verification of leakage current distribution in the custom macro circuit.
